(19) United States
(12) Patent Application Publication
(10) Pub. No.: US 2025/0337054 A1
(43) Pub. Date: Oct. 30, 2025

(54) HEAT INSULATING SHEET FOR RECHARGEABLE LITHIUM BATTERY AND RECHARGEABLE LITHIUM BATTERY MODULE INCLUDING THE SAME

(71) Applicant: SAMSUNG SDI CO., LTD., Yongin-si (KR)

(72) Inventors: Jung Hyo LEE, Suwon-si (KR); A Rum YU, Suwon-si (KR); Myung Heui WOO, Suwon-si (KR); Seung Yong YANG, Suwon-si (KR); Jae Hyun LEE, Suwon-si (KR); Yun Sung YANG, Suwon-si (KR); Hye Jin PARK, Suwon-si (KR); Ha Na RA, Suwon-si (KR)

(73) Assignee: SAMSUNG SDI CO., LTD., Yongin-si (KR)

(21) Appl. No.: 19/193,365

(22) Filed: Apr. 29, 2025

(30) Foreign Application Priority Data
Apr. 30, 2024 (KR) 10-2024-0057495

(51) Int. Cl. H01M 10/658; C04B 37/00; C08K 7/14; C08K 7/22; C09J 11/04; C09J 129/04; C09J 175/04; F16L 59/02; H01M 10/0525; H01M 10/6555

(52) U.S. Cl. CPC H01M 10/658; C04B 37/008; C09J 11/04; C09J 129/04; C09J 175/04; F16L 59/029; H01M 10/0525; H01M 10/6555; C04B 2237/341; C08K 7/14; C08K 7/22; C08K 2201/014; H01M 2220/20

(57) ABSTRACT

The present disclosure relates to a heat insulation sheet for a rechargeable lithium battery, and a rechargeable lithium battery module including the heat insulation sheet. The heat insulation sheet for a rechargeable lithium battery includes a base sheet including a first base layer and an aerogel-containing layer that are stacked sequentially, and an inorganic layer formed on substantially the entire surface of the base sheet. The aerogel-containing layer includes a fibrous support, an aerogel, and a binder, and the aerogel-containing layer includes the fibrous support in an amount ranging from about 5 wt % to about 70 wt %, the aerogel in an amount ranging from about 10 wt % to about 90 wt %, and the binder in an amount ranging from about 0.5 wt % to about 20 wt %.

### CROSS-REFERENCE TO RELATED APPLICATION

The present application claims the benefit of priority to Korean Patent Application No. 10-2024-0057495, filed on Apr. 30, 2024 in the Korean Intellectual Property Office, the entire disclosure of which being incorporated herein by reference.

### BACKGROUND

### 1. Field of the Disclosure

The present disclosure relates to a heat insulation sheet for a rechargeable lithium battery, and a rechargeable lithium battery module including the heat insulation sheet.

### 2. Discussion of Related Art

With increasing presence of electronic devices using batteries, such as, e.g., mobile phones, notebook computers, electric vehicles, and the like, the demand for rechargeable batteries having high energy density and high capacity is increasing. Therefore, improving the performance of rechargeable lithium batteries may be advantageous.

A rechargeable lithium battery typically includes a positive electrode and a negative electrode that include an active material capable of the intercalation and deintercalation of lithium ions, and produces electric energy by oxidation and reduction reactions when the lithium ions are intercalated into and deintercalated from the positive electrode and the negative electrode.

A plurality of rechargeable lithium batteries may be included to form a rechargeable lithium battery module. In the rechargeable lithium battery module, it may be advantageous to block heat propagation and/or heat transfer between adjacent cells.

### SUMMARY

One example embodiment includes a heat insulation sheet for a rechargeable lithium battery with desired or improved heat insulation, compression properties, dust resistance, heat resistance, and durability.

Another example embodiment includes a rechargeable lithium battery module including the heat insulation sheet for a rechargeable lithium battery.

According to one example embodiment, a heat insulation sheet for a rechargeable lithium battery includes a base sheet including a first base layer and an aerogel-containing layer that are stacked, e.g., sequentially stacked, and an inorganic layer formed on the entire surface of the base sheet. The aerogel-containing layer includes a fibrous support, an aerogel, and a binder, and the aerogel-containing layer includes the fibrous support in an amount ranging from about 5 wt % to about 70 wt %, the aerogel in an amount ranging from about 10 wt % to about 90 wt %, and the binder in an amount ranging from about 0.5 wt % to about 20 wt %.

According to another example embodiment, a rechargeable lithium battery module includes a plurality of battery cells arranged to face each other, and the heat insulation sheet for a rechargeable lithium battery, which is disposed between the plurality of battery cells.

### BRIEF DESCRIPTION OF THE DRAWINGS

FIG. 1 is a cross-sectional view of a heat insulation sheet for a rechargeable lithium battery, according to one example embodiment.

FIG. 2 is a cross-sectional view of a heat insulation sheet for a rechargeable lithium battery, according to another example embodiment.

FIG. 3 is a perspective view of a rechargeable lithium battery module, according to one example embodiment.

FIG. 4 is an exploded perspective view of the rechargeable lithium battery module, according to one example embodiment.

FIG. 5 is a cross-sectional view schematically illustrating a battery cell, according to one example embodiment.

FIG. 6 is a cross-sectional view schematically illustrating a battery pack, according to one example embodiment.

FIG. 7 is a cross-sectional view schematically illustrating the battery pack, according to one example embodiment.

FIG. 8 is a view illustrating a vehicle body and vehicle body parts, according to one example embodiment.

FIG. 9 is a view illustrating a vehicle body and vehicle body parts, according to one example embodiment.

### DETAILED DESCRIPTION

Hereinafter, example embodiments of the present disclosure are described in detail. However, the embodiments are presented as examples, and the present disclosure is not limited thereto, and the present disclosure is only defined by the scope of the appended claims.

Unless otherwise stated herein, when a part such as a layer, a membrane, an area, a plate, and the like, is described as being disposed “on” another part, it includes not only a case where the part is “directly on” another part, but also a case where there are other parts therebetween.

Unless otherwise stated herein, the singular may also include the plural. In addition, unless otherwise stated, “A or B” may indicate “including A, including B, or including A and B.” In the present specification, “a combination thereof” may indicate a mixture, stack, composite, copolymer, alloy, blend, and reaction product of constituents.

When the terms “about” or “substantially” are used in this specification in connection with a numerical value, it is intended that the associated numerical value include a tolerance of ±10% around the stated numerical value. When ranges are specified, the range includes all values therebetween such as increments of 0.1%.

### Heat Insulation Sheet for a Rechargeable Lithium Battery:

A heat insulation sheet for a rechargeable lithium battery according to one example embodiment includes a base sheet including a first base layer and an aerogel-containing layer that are stacked, e.g., sequentially stacked, and an inorganic layer formed on substantially the entire surface of the base sheet. The aerogel-containing layer includes a fibrous support, an aerogel, and a binder, and the aerogel-containing layer includes the fibrous support in an amount ranging from about 5 wt % to about 70 wt %, the aerogel in an amount ranging from about 10 wt % to about 90 wt %, and the binder in an amount ranging from about 0.5 wt % to about 20 wt %.

The base sheet according to one example embodiment may further include a second base layer stacked on the aerogel-containing layer.

The heat insulation sheet can provide desired or improved heat insulation, dust resistance, heat resistance, and durability by including the aerogel-containing layer and the inorganic layer. Both the aerogel-containing layer and the inorganic layer can contribute to improving the heat insulation, dust resistance, heat resistance, and durability of the heat insulation sheet.

Hereinafter, the heat insulation sheet according to one example embodiment is described in detail.

### Base Sheet

The base sheet includes a first base layer and an aerogel-containing layer that are stacked, e.g., sequentially stacked.

The base sheet may include the first base layer, the aerogel-containing layer, and a second base layer that are stacked, e.g., sequentially stacked.

### First Base Layer

The first base layer may support the aerogel-containing layer and the second base layer of the heat insulation sheet.

The first base layer may be included in one or more layers, that is, one layer or two or more layers in the heat insulation sheet.

The first base layer may be or include a film, a thin film, or a sheet formed of or including at least one of a resin, a metal-based inorganic material, inorganic materials other than the metal-based material, or a composite thereof.

The resin may include, for example, one or more of polyolefin-based resins such as polyethylene or polypropylene; polystyrene-based resins; polyester-based resins such as polyethylene terephthalate or polybutylene terephthalate; polyamide-based resins; and polyimide-based resins.

The metal-based inorganic material may include, for example, one or more of copper, nickel, cobalt, iron, chromium, vanadium, palladium, ruthenium, rhodium, molybdenum, tungsten, iridium, silver, gold, and platinum. The metal-based inorganic material may undergo anti-corrosion treatment, insulation treatment, and the like. as needed.

Inorganic materials other than the metal-based material may include one or more of calcium carbonate, talc, and mica.

According to one example embodiment, the heat insulation sheet may include inorganic materials other than the metal-based material as the first base layer, and for example may include a mica sheet. Mica can improve the heat insulation properties and durability of the heat insulation sheet.

The first base layer may have a thickness in a range of about 10 μm to about 5000 μm, for example, from 50 μm to 3000 μm or from 100 μm to 1000 μm. Within the above range, the second base layer may be included in the heat insulation sheet.

### Aerogel-Containing Layer

The aerogel-containing layer may be or include a separate layer that is independent of the first base layer. Here, “separate layer that is independent of” indicates that the aerogel-containing layer is not formed through impregnation, and the like in the first base layer, but that the first base layer and the aerogel-containing layer are substantially completely separated and formed as non-continuous layers.

The aerogel-containing layer may be included in one or more layers, that is, one layer or two or more layers in the heat insulation sheet.

The aerogel-containing layer includes a fibrous support, an aerogel, and a binder.

The fibrous support may help to support the aerogel-containing layer and improve the compression properties of the heat insulation sheet.

The fibrous support may be or include, for example, a wool mat or a chopped strand mat.

Fibers constituting the fibrous support may include one or more of natural fibers, glass fibers, carbon fibers, graphite fibers, mineral fibers, and polymer fibers. For example, the compression properties of the fibrous support can be further improved by using glass fibers.

The natural fiber may be or include a fiber made of or including one or more of hemp, jute, flax, coir, kenaf, and cellulose. The mineral fiber may be or include a fiber made of or including one or more of basalt, wollastonite, alumina, silica, slag, and rock. The polymer fiber may be or include a fiber made of or including one or more of nylons, polyimides; polyamides, polybenzimidazoles, polybenzoxazoles, polyamide-imides, polyesters such as polyethylene terephthalate and polybutylene terephthalate, and polyolefins such as polyethylene and polypropylene.

For example, the fibrous support may be or include glass wool.

The fibers in the fibrous support may have an aspect ratio in a range of about 1 or more, for example, ranging from about 1 to about 5,000. Within the above range, the aerogel-containing layer can be firmly formed, and the durability of the heat insulation sheet can be improved. Herein, “aspect ratio” indicates a ratio of a length of the fiber to a diameter of the fiber in the fibrous support.

The fiber in the fibrous support may have a length ranging from about 50 μm to about 1000 μm, for example, from 70 μm to 800 μm or from 100 μm to 600 μm. Within the above range, the aerogel-containing layer can be firmly formed, and the durability of the heat insulation sheet can be improved.

The fibers in the fibrous support may have a diameter ranging from about 0.1 μm to about 20 μm, for example, from 0.1 μm to 15 μm, from 0.1 μm to 5 μm, from 1 μm to 15 μm, or from 3 μm to 10 μm. Within the above range, the aerogel-containing layer can be firmly formed, and the durability of the heat insulation sheet can be improved. Herein, “diameter” may indicate a diameter when a cross section of the fiber is circular, and may be the longest diameter when the above cross section is not circular.

The fibrous support may be included in an amount ranging from about 5 wt % to about 70 wt % of the aerogel-containing layer. Within the above range, it is possible to readily improve the durability of the heat insulation sheet. For example, the fibrous support may be included in an amount ranging from about 10 wt % to about 60 wt %, from 25 wt % to 60 wt %, or from 25 wt % to 50 wt % of the aerogel-containing layer. Within the above range, it is possible to readily improve the flexibility and durability of the heat insulation sheet.

The aerogel may provide the heat insulating effect to the aerogel-containing layer.

According to one example embodiment, the aerogel may have a specific surface area ranging from about 500 m²/g to about 1000 m²/g. For example, the specific surface area may range from 500 m²/g to 950 m²/g, from 550 m²/g to 950 m²/g, or from 600 m²/g to 900 m²/g. Within the above range, it is possible to readily reduce or prevent heat transfer and heat propagation between a plurality of battery cells. Herein, “specific surface area” may refer to a specific surface area based on Brunauer Emmett Teller (BET) specific surface area analysis.

According to one example embodiment, the aerogel may have an average particle diameter ranging from about 5 μm to about 200 μm. For example, the aerogel may have an average particle diameter ranging from 10 μm to 100 μm, or from 20 μm to 50 μm. Within the above range, it is possible to readily delay heat transfer between a plurality of battery cells by improving the heat insulation properties of the heat insulation sheet. Herein, “average particle diameter” is an average particle diameter D50, which refers to a diameter of a particle with a cumulative volume of about 50% by volume in the particle size distribution. The average particle diameter D50 may be measured by methods known to those skilled in the art, for example, measured using a particle size analyzer, or measured using a transmission electron micrograph, or a scanning electron micrograph. As another method, the particle size distribution may be measured using a measurement device using dynamic light scattering, and an average particle diameter D50 value may be obtained by performing data analysis, counting the number of particles in each particle size range, and then calculating the D100 value therefrom. Alternatively, the particle size distribution may be measured using a laser diffraction method. When measuring the average particle diameter by the laser diffraction method, for example, the average particle diameter D50 based on 50% of a particle diameter distribution in the measuring device may be calculated by dispersing particles to be measured in a dispersion medium, then introducing the dispersion medium into a commercially available laser diffraction particle diameter measuring device (e.g., Microtrac's MT 3000), and radiating ultrasonic waves of about 28 kHz at output power of 60 W.

The aerogel may be included in an amount ranging from about 10 wt % to about 90 wt % of the aerogel-containing layer. Within the above range, it is possible to readily improve the heat insulation properties of the heat insulation sheet. For example, the aerogel may be included in an amount ranging from about 30 wt % to about 70 wt %, from 30 wt % to 65 wt %, or from 45 wt % to 65 wt % of the aerogel-containing layer. Within the above range, the heat insulation properties of the heat insulation sheet can be improved.

The binder can readily improve the compression properties and dust resistance of the heat insulation sheet.

According to one example embodiment, the binder may be or include a water-based binder. The water-based binder has high solubility in water among solvents to be described below, and thus may allow the aerogel-containing layer to be readily formed.

According to one example embodiment, the water-based binder may include one or more of a cationic water-soluble polymer, an anionic water-soluble polymer, and a nonionic water-soluble polymer.

The cationic water-soluble polymer may be or include a polymer having a functional group such as, e.g., at least one of an amine group, an ammonium group, a phosphonium group, a sulfonium group, or a salt thereof, for example, a polymer having an amine group. For example, the cationic water-soluble polymer may include one or more of polyethyleneamine and polyamine.

The anionic water-soluble polymer may be or include a polymer having a functional group such as at least one of a carboxylic acid group, a sulfonic acid group, an ester group, a phosphoric acid ester group, or a salt thereof, for example, a polymer having a carboxylic acid group. For example, the anionic water-soluble polymer may be or include polymaleic acid.

The nonionic water-soluble polymer may include one or more of polyvinyl alcohol, polyethylene glycol, polyacrylamide, polyvinylpyrrolidone, polyurethane, and polyester. The nonionic water-soluble polymer may be or include a water-dispersible or water-based polymer.

According to one example embodiment, the binder may include a mixture of one or more of polyvinyl alcohol, polyethylene glycol, polyacrylamide, and polyvinylpyrrolidone, and one or more of polyurethane and polyester. In this case, it may be possible to provide dispersion characteristics by one or more of polyvinyl alcohol, polyethylene glycol, polyacrylamide, and polyvinylpyrrolidone, and fire resistance properties by one or more of polyurethane and polyester. For example, a mixture of polyvinyl alcohol and polyurethane may be included.

According to one example embodiment, a weight ratio of one or more of polyvinyl alcohol, polyethylene glycol, polyacrylamide, and polyvinylpyrrolidone to one or more of polyurethane and polyester ranges from about 1:1 to about 1:5, for example, from 1:1 to 1:4 or from 1:2 to 1:3. Within the above range, the heat insulation, dust resistance, fire resistance, and mechanical properties of the heat insulation sheet can be improved.

The binder may be included in an amount ranging from about 0.5 wt % to about 20 wt % of the aerogel-containing layer. When the binder is included in an amount of about 0.5 wt % or more, the dust resistance and durability of the heat insulation sheet can be readily improved. When the binder is included in an amount of about 20 wt % or less, the durability of the heat insulation sheet can be readily improved. For example, the binder may be included in an amount ranging from about 2 wt % to about 15 wt % or from about 5 wt % to about 10 wt % of the aerogel-containing layer. Within the above range, it is possible to readily improve the dust resistance of the heat insulation sheet.

According to one example embodiment, a total of the fibrous support, the aerogel, and the binder may be included in an amount of about 95 wt % or more, for example, ranging from 95 wt % to 100 wt %, from 99 wt % to 100 wt %, or 100 wt % of the aerogel-containing layer. Within the above range, the above effects of the heat insulation sheet can be readily exhibited.

The aerogel-containing layer may further include one or more of a dispersant and a silane-based compound.

The dispersant can improve the dispersion of the aerogel in the composition for the aerogel-containing layer, thereby enabling the manufacturing of an aerogel-containing layer in which the fibrous support and the aerogel are uniformly dispersed.

The dispersant may include one or more of a surfactant and a phosphorus salt. The surfactant may include one or more of a nonionic surfactant, anionic surfactant, and zwitterionic surfactant. The surfactant may include one or more of natural surfactants such as lecithin, and non-natural surfactants such as chemicals. The phosphorus salt may be or include a phosphate-based salt.

The aerogel may be included in an amount ranging from about 0.1 wt % to about 6 wt % of the aerogel-containing layer. For example, the dispersant may be included in an amount ranging from 0.1 wt % to 5 wt % or from 0.1 wt % to 3 wt %. Within the above range, it is possible to manufacture a composition for an aerogel-containing layer at low cost, and provide a heat insulation sheet with further improved heat insulation, durability, and dust resistance.

According to one example embodiment, the binder and the dispersant may be included in a weight ratio of about 1:0.001 to about 1:0.7, for example, 1:0.001 to 1:0.67, 1:0.001 to 1:0.5, or 1:0.001 to 1:0.3. Within the above range, when the binder and the dispersant are included together, it is possible to manufacture an aerogel-containing layer in which the aerogel is further uniformly dispersed.

The silane-based compound can improve the dispersibility of the aerogel in the aerogel-containing layer.

According to one example embodiment, the silane-based compound may include one or more of alkyl group-containing trialkoxysilanes such as methyltrimethoxysilane, methyltriethoxysilane, ethyltrimethoxysilane, ethyltriethoxysilane, or octadecyltrimethoxysilane, epoxy group-containing trialkoxysilanes such as glycidoxypropyltrimethoxysilane, and unsaturated group-containing trialkoxysilanes such as 3-(trimethoxysilyl)propyl methacrylate.

The aerogel-containing layer may further include typical additives known to those skilled in the art. The additives include one or more of wetting agents, emulsifiers, compatibilizers, viscosity regulators, pH regulators, stabilizers, antioxidants, acidic or basic trapping agents, metal deactivators, antifoaming agents, antistatic agents, thickeners, adhesion improvers, binders, flame retardants, impact modifiers, pigments, dyes, colorants, and deodorants.

According to one example embodiment, the aerogel-containing layer may have a thickness ranging from about 100 μm to about 10,000 μm, for example, from 500 μm to 5000 μm or from 1,000 μm to 3,000 μm. Within the above range, the second base layer may be included in the heat insulation sheet.

The aerogel-containing layer may be formed using a composition for an aerogel-containing layer including the fibrous support, the aerogel, and the binder. The composition for an aerogel-containing layer may further include one or more of the dispersant, the silane-based compound, and the additive.

In one example embodiment, the composition for an aerogel-containing layer may include the fibrous support in an amount ranging from about 5 wt % to about 70 wt %, for example, from 25 wt % to 60 wt %, from 10 wt % to 60 wt %, or 25 wt % to 50 wt %, the aerogel in an amount ranging from about 10 wt % to about 90 wt %, for example, from 30 wt % to 70 wt %, from 30 wt % to 65 wt %, or from 45 wt % to 65 wt %, and the binder in an amount ranging from about 0.5 wt % to about 20 wt %, for example, from 2 wt % to 15 wt % or from 5 wt % to 10 wt % based on solid content.

A method of manufacturing the aerogel-containing layer is described in detail below.

### Second Base Layer

The second base layer may support the first base layer and the aerogel-containing layer of the heat insulation sheet.

The second base layer may be included in one or more layers, that is, one layer or two or more layers in the heat insulation sheet.

The second base layer may be stacked on the aerogel-containing layer. The aerogel-containing layer may be a separate layer that is independent of the second base layer. Herein, “separate layer that is independent of” indicates that the aerogel-containing layer is not formed through impregnation, and the like, in the second base layer, but that the second base layer and the aerogel-containing layer are substantially completely separated and formed as non-continuous layers.

The second base layer may be formed of or include at least one of a film, a thin film, or a sheet formed of or including a resin, a metal-based inorganic material, inorganic materials other than the metal-based material, or a composite thereof. The resin, the metal-based inorganic material, and the inorganic materials other than the metal-based material are substantially the same as the metal-based inorganic material and the inorganic materials of the first base layer.

According to one example embodiment, the heat insulation sheet may include inorganic materials other than the metal-based material as the second base layer, and for example include a mica sheet. Mica can improve the heat insulation properties and durability of the heat insulation sheet.

The second base layer may have a thickness ranging from about 10 μm to about 5000 μm, for example, from 50 μm to 3000 μm or from 100 μm to 1000 μm. Within the above range, the second base layer may be included in the heat insulation sheet.

### Inorganic Layer

The inorganic layer is formed on substantially the entire surface of the base sheet. For example, the inorganic layer may be formed on all of an upper surface of the base sheet, a lower surface facing the upper surface, and side surfaces connecting the upper surface to the lower surface.

According to one example embodiment, the inorganic layer may be formed directly on the base sheet. Here, “formed directly” indicates that no adhesive layer, bonding layer, and the like, is formed between the base sheet and the inorganic layer.

The inorganic layer may include an inorganic material, and the inorganic material may be stably fixed to each, or at least one, of the first base layer, the aerogel-containing layer, and the second base layer, and may include any particle with low thermal conductivity without limitation.

For example, the inorganic material may be or include at least one of a metal, a non-metal, an intermetallic compound or alloy, a non-metallic compound or alloy, a metal or non-metal oxide, a metal or non-metal fluoride, a metal or non-metal nitride, a metal or non-metal carbide, a metal or non-metal oxynitride, a metal or non-metal boride, a metal or non-metal oxyboride, a metal or non-metal silicide, or a mixture thereof. Metals or non-metals may include at least one of silicon (Si), aluminum (Al), selenium (Se), zinc (Zn), antimony (Sb), indium (In), germanium (Ge), tin (Sn), bismuth (Bi), a transition metal, a lanthanide metal, and the like, but are not limited thereto. For example, the inorganic material may be or include at least one of silicon oxide (SiOₓ), silicon nitride (SiNₓ), silicon oxygen nitride (SiOₓN_{y}), aluminum oxide (AlₓO_{y}), AlOₓ including ZnSe, ZnO, Sb₂O₃, In₂O₃, SnO₂, and the like.

For example, the inorganic material may include one or more of silicon oxide, for example, silica and aluminum oxide, for example, alumina.

The inorganic material may be spherical including a perfect sphere shape, amorphous, plate-shaped, cubic, and the like.

The inorganic material may have an average particle diameter ranging from about 0.005 μm to about 10 μm, for example, from 0.01 μm to 1 μm. Within the above range, the inorganic layer may be readily formed.

The inorganic layer may further include a binder to allow the inorganic material to be readily coated. The binder may include one or more of a water-based binder and an organic binder, as long as the binder does not affect the above-described effects of the heat insulation sheet.

In one example embodiment, the binder may include one or more of polyvinyl alcohol, polyethylene glycol, polyacrylamide, and polyvinylpyrrolidone, for example, polyvinyl alcohol.

In one example embodiment, the inorganic layer may include the inorganic material in an amount ranging from about 70 wt % to about 99 wt %, for example, from 80 wt % to 90 wt % and the binder in an amount ranging from 1 wt % to 30 wt %, for example, from 10 wt % to 20 wt %. Within the above range, the above effects of the present disclosure can be readily achieved.

The inorganic layer may have a thickness ranging from about 1 μm to about 1000 μm, for example, from 10 μm to 500 μm or from 30 μm to 200 μm. Within the above range, the inorganic layer may be included in the heat insulation sheet and the battery module.

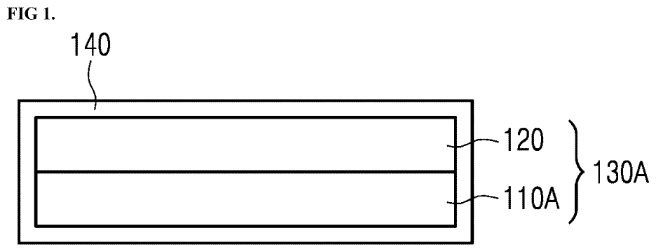

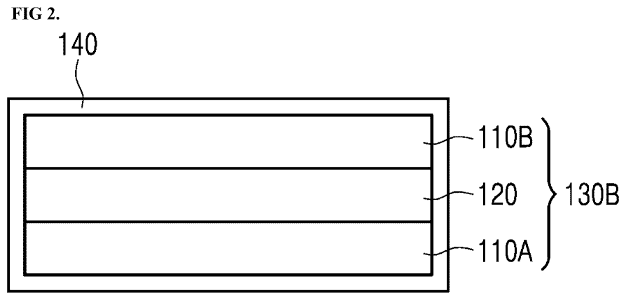

FIGS. 1 and 2 are cross-sectional views of a heat insulation sheet for a rechargeable lithium battery, according to one example embodiment.

Referring to FIG. 1, the heat insulation sheet for a rechargeable lithium battery may include a base sheet 130A including a first base layer 110A and an aerogel-containing layer 120 on the first base layer 110A, and an inorganic layer 140 completely, or substantially completely, surrounding the entire surface of the base sheet 130A.

Referring to FIG. 2, the heat insulation sheet for a rechargeable lithium battery may include a base sheet 130B including a first base layer 110A, a second base layer 110B facing the first base layer 110A, an aerogel-containing layer 120 stacked between the first base layer 110A and the second base layer 110B, and an inorganic layer 140 completely, or substantially completely, surrounding the entire surface of the base sheet 130B.

Hereinafter, a method of manufacturing the heat insulation sheet according to one example embodiment is described.

According to one example embodiment, the method of manufacturing the heat insulation sheet may include preparing a composition for an aerogel-containing layer including a fibrous support, aerogel, and a binder, manufacturing a base sheet by coating a first base layer with the composition for an aerogel-containing layer and drying the composition for an aerogel-containing layer coated on the first base layer, and forming an inorganic layer on the entire surface of the base sheet.

The composition for an aerogel-containing layer includes a fibrous support, an aerogel, and a binder. The fibrous support, the aerogel, and the binder are the same as the fibrous support, the aerogel, and the binder described above.

The composition for an aerogel-containing layer may further include one or more of the dispersant, the silane-based compound, and the additive.

The composition for an aerogel-containing layer may further include a solvent.

The solvent may include one or more of a polar solvent and a non-polar solvent.

The polar solvent may include at least one of water, an alcohol-based solvent, or a combination thereof. The water may include, for example, at least one of purified water, ultrapure water, or a combination thereof. The alcohol-based solvent may include, for example, one or more of methanol, ethanol, propanol, pentanol, butanol, hexanol, ethylene glycol, propylene glycol, diethylene glycol, and glycerol.

The non-polar solvent may include a hydrocarbon-based solvent. For example, the hydrocarbon-based solvent may include one or more of aliphatic hydrocarbon solvents such as hexane, pentane, and heptane, for example, alkane solvents, and aromatic hydrocarbon solvents such as toluene and benzene.

For example, the solvent may include water. When water is included as a solvent, raw material costs and post-treatment costs can be effectively reduced.

The solvent may be included so that a weight ratio of the solvent and a total solid content of the composition for an aerogel-containing layer ranges from about 1:1 to about 1:90. For example, the weight ratio of the solvent and the total solid content of the composition for an aerogel-containing layer may range from about 1:50 to about 1:70, from 1:20 to 1:30, or from 1:2 to 1:10. Within the above range, the composition for an aerogel-containing layer may be coated by controlling the viscosity of the composition for an aerogel-containing layer.

The composition for an aerogel-containing layer may be prepared using the solvent, the fibrous support, the aerogel, and the binder.

According to one example embodiment, the composition for an aerogel-containing layer may include preparing a first mixed solution by mixing the binder with the solvent, preparing a second mixed solution by mixing an aerogel with the first mixed solution, and preparing the composition for an aerogel-containing layer by mixing the fibrous support with the second mixed solution. In the preparing of the first mixed solution, the dispersant, the silane-based compound, the additive, and the like, may be additionally mixed.

When mixing in each of the first operation, the second operation, and the preparing of the composition for an aerogel-containing layer, the mixing may be performed using a mixer. Examples of the mixer may include a planetary mixer, a Thinky mixer, and the like.

The planetary mixer may include one or more types of planetary blades and one or more types of high-speed dispersion blades. The planetary blade and the high-speed dispersion blade may rotate continuously about their axes. A rotational speed may be expressed in revolutions per minute (rpm).

According to one example embodiment, the planetary mixer may include a first blade and a second blade that have different rotational axes. For example, the first blade may be a low-speed blade, and the second blade may be a high-speed blade. Herein, low speed and high speed are relative rotational speeds. For example, the first blade may be an open blade, and the second blade may be a despa blade. A rotational speed of the first blade may range from, for example, about 10 rpm to about 100 rpm or from 10 rpm to 60 rpm. A rotational speed of the second blade may range from 100 rpm to 2000 rpm.

According to one example embodiment, before performing the drying, a second base layer may be additionally stacked on the applied composition for an aerogel-containing layer.

The aerogel-containing layer may be prepared by applying the composition for an aerogel-containing layer, and then drying the composition. The drying may be performed at a temperature ranging from about 25° C. to about 100° C., from 45° C. to 90° C., or from 60° C. to 85° C. Within the above range, an aerogel-containing layer with desired or improved mechanical strength may be formed without a separate adhesive member or an adhesive, while reducing or preventing peeling between the first base layer and the aerogel-containing layer and peeling between the aerogel-containing layer and the second base layer.

The inorganic layer may be manufactured by applying a slurry including an inorganic material on substantially the entire surface of the base sheet through coating, spraying, and the like, and drying the slurry.

The slurry may further include an aqueous solvent or an organic solvent to ensure that the inorganic layer is uniformly formed.

The drying may be performed at a temperature ranging from about 25° C. to about 100° C., from 45° C. to 90° C., or from 60° C. to 85° C. Within the above range, an aerogel-containing layer with desired or improved mechanical strength may be formed without a separate adhesive member or adhesive, while reducing or preventing peeling between the base sheet and the inorganic layer.

Another example embodiment includes a rechargeable lithium battery module including a plurality of battery cells arranged to face each other, and heat insulating sheets for a rechargeable lithium battery that are between the plurality of battery cells.

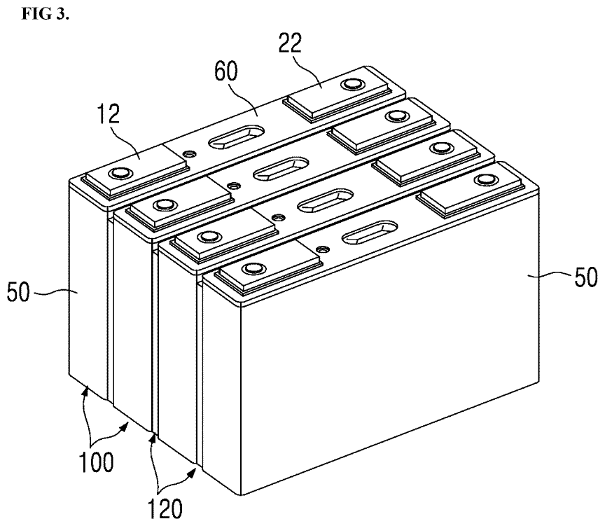

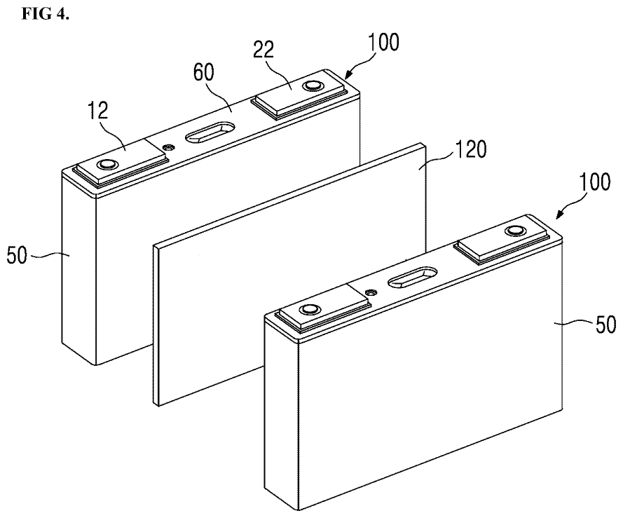

FIGS. 3 and 4 are a perspective view and an exploded perspective view, respectively, of a rechargeable lithium battery module, according to one example embodiment.

Referring to FIGS. 3 and 4, a rechargeable lithium battery module may include a plurality of battery cells 100 arranged to face each other, and heat insulating sheets 200 that are between the battery cells 100.

The heat insulating sheets 200 for a rechargeable lithium battery may have a plate shape. One surface of the heat insulating sheet 200 may come in contact with one surface of one battery cell 100, and the other surface of the heat insulating sheet 200 opposite to the one surface thereof may come in contact with one surface of another battery cell 100.

The battery cell 100 may include a case 50 configured to accommodate an electrode assembly including a positive electrode and a negative electrode, a cap plate 60 coupled to the case 50 to seal the case 50, and a positive electrode terminal 12 and a negative electrode terminal 22 electrically connected to the positive electrode and the negative electrode of the electrode assembly and protruding to the outside of the cap plate 60.

The positive electrode may include a current collector, and a positive electrode active material layer on the current collector. The positive electrode active material layer may include a positive electrode active material, and may further include a binder and/or a conductive additive.

The content of the positive electrode active material may range from about 90 wt % to about 99.5 wt % with respect to 100 wt % of the positive electrode active material layer, and the content of the binder and the content of the conductive additive may each be in a range of about 0.5 wt % to about 5 wt % with respect to 100 wt % of the positive electrode active material layer.

Al may be included as the current collector, but the current collector is not limited thereto.

As the positive electrode active material, a compound capable of reversible intercalation and deintercalation of lithium (a lithiated intercalation compound) may be included. For example, one or more of composite oxides of lithium and a metal such as or including at least one of cobalt, manganese, nickel and a combination thereof, may be included.

The composite oxides may be or include lithium transition metal composite oxides.

Examples of the composite oxides may include at least one of lithium nickel oxide, lithium cobalt oxide, lithium manganese oxide, a lithium iron phosphate compound, cobalt-free nickel-manganese oxide, or a combination thereof.

As one example, a compound represented by any one of the following chemical formulas may be included as the composite oxide. LiₐA_{1-b}XbO_{2-c}D_{c}(0.90≤a≤1.8, 0≤b≤0.5, 0≤c≤0.05); LiₐMn_{2-b}X_{b}O_{4-c}D_{c}(0.90≤a≤1.8, 0≤b≤0.5, 0≤c≤0.05); LiₐNi_{1-b-c}Co_{b}X_{c}O_{2-α}D_{α}(0.90≤a≤1.8, 0≤b≤0.5, 0≤c≤0.5, 0<α<2); LiₐNi_{1-b-c}Mn_{b}X_{c}O_{2-α}D_{α}(0.90≤a≤1.8, 0≤b≤0.5, 0≤c≤0.5, 0<α<2); LiₐNi_{b}Co_{c}L¹_{d}GₑO₂(0.90≤a≤1.8, 0≤b≤0.9, 0≤c≤0.5, 0≤d≤0.5, 0≤e≤0.1); LiₐNiG_{b}O₂(0.90≤a≤1.8, 0.001≤b≤0.1); LiₐCoG_{b}O₂(0.90≤a≤1.8, 0.001≤b≤0.1); LiₐMn_{1-b}G_{b}O₂(0.90≤a≤1.8, 0.001≤b≤0.1); LiₐMn₂G_{b}O₄(0.90≤a≤1.8, 0.001≤b≤0.1); LiₐMn_{1-g}G_{g}PO₄(0.90≤a≤1.8, 0≤g≤0.5); Li(_{3-f})Fe₂(PO₄)₃(0≤f≤2); LiₐFePO₄(0.90≤a≤1.8).

In the above chemical formulas, A is or includes at least one of Ni, Co, Mn, or a combination thereof, X is or includes at least one of Al, Ni, Co, Mn, Cr, Fe, Mg, Sr, V, a rare earth element, or a combination thereof, D is or includes at least one of O, F, S, P, or a combination thereof, G is or includes at least one of Al, Cr, Mn, Fe, Mg, La, Ce, Sr, V, or a combination thereof, and L¹ is or includes at least one of Mn, Al, or a combination thereof.

The negative electrode includes a current collector and a negative electrode active material layer on the current collector. The negative electrode active material layer may include a negative electrode active material, and may further include a binder and/or a conductive additive.

For example, the negative electrode active material layer may include about 90 wt % to about 99 wt % of the negative electrode active material, about 0.5 wt % to about 5 wt % of the binder, and about 0 wt % to about 5 wt % of the conductive additive.

The negative electrode active material includes at least one of a material capable of reversible intercalation/deintercalation of lithium ions, lithium metal, a lithium metal alloy, a material capable of doping and dedoping lithium, or a transition metal oxide.

The material capable of reversible intercalation/deintercalation of lithium ions is or includes a carbon-based negative electrode active material, and may include, for example, crystalline carbon, amorphous carbon, or a combination thereof. Examples of the crystalline carbon may include graphite such as natural graphite or artificial graphite, and examples of the amorphous carbon may include at least one of soft carbon, hard carbon, mesophase pitch carbide, and calcinated coke.

At least one of a Si-based negative electrode active material or an Sn-based negative electrode active material may be included as the material capable of doping and dedoping lithium. The Si-based negative electrode active material may be or include at least one of silicon, a silicon-carbon composite, SiOₓ (0<x<2), an Si-based alloy, or a combination thereof.

The silicon-carbon composite may be or include a composite of silicon and amorphous carbon. According to one example embodiment, the silicon-carbon composite may have a form including a silicon particle, and amorphous carbon coated on a surface of the silicon particle.

The silicon-carbon composite may further include crystalline carbon. For example, the silicon-carbon composite may include a core including crystalline carbon and a silicon particle, and an amorphous carbon coating layer located on a surface of the core.

A nonaqueous binder, an aqueous binder, a dry binder, or a combination thereof may be included as the binder. When the aqueous binder is included as the negative electrode binder, a cellulose-based compound that can impart viscosity may be further included.

As the negative electrode current collector, at least one of copper foil, nickel foil, stainless steel foil, titanium foil, nickel foam, copper foam, a polymer substrate having a conductive metal coated thereon, or combinations thereof, may be included.

An electrolyte for a rechargeable lithium battery includes a nonaqueous organic solvent and a lithium salt.

The nonaqueous organic solvent is configured as a medium through which ions involved in an electrochemical reaction of a battery can move.

The nonaqueous organic solvent may be or include at least one of a carbonate-based, ester-based, ether-based, ketone-based, or alcohol-based solvent, an aprotic solvent, or a combination thereof. Any of the above may be included alone as the nonaqueous organic solvent, or two or more of the above may be mixed and included as the nonaqueous organic solvent.

For example, when the carbonate-based solvent is included, a cyclic carbonate and a chain carbonate may be mixed.

A separator may be present between a positive electrode and a negative electrode according to the type of rechargeable lithium battery. At least one of polyethylene, polypropylene, polyvinylidene fluoride, or a multi-layer film of two or more thereof may be included as the separator.

The separator may include a porous base and a coating layer on one surface, or on both surfaces, of the porous base and including an organic material, an inorganic material, or a combination thereof.

The organic material may include a polyvinylidene fluoride-based polymer or a (meth)acryl-based polymer.

The inorganic material may include an inorganic particle such as or including at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but is not limited thereto.

The organic material and inorganic material may be included by being mixed in a single coating layer, or may be included in a form in which a coating layer including the organic material and a coating layer including the inorganic material are stacked.

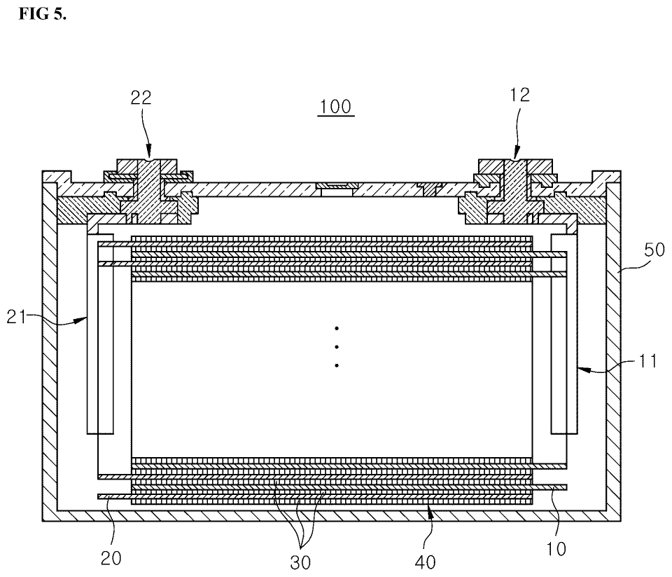

FIG. 5 is a cross-sectional view schematically illustrating the battery cell 100 according to one example embodiment.

Referring to FIG. 5, the battery cell 100 may include an electrode assembly 40 including a positive electrode 10, a negative electrode 20, and a separator 30 interposed between the positive electrode 10 and the negative electrode 20; a case 50 in which the electrode assembly 40 is accommodated; a positive electrode lead tab 11 connected to the positive electrode 10; a positive electrode terminal 12 connected to the positive electrode lead tab 11; a negative electrode lead tab 21 connected to the negative electrode 20; and a negative electrode terminal 22 connected to the negative electrode lead tab 21.

The rechargeable lithium battery module according to one example embodiment may be applicable to, e.g., vehicles, mobile phones, and/or various other forms of electric devices, but the present disclosure is not limited thereto.

The battery module according to the above-described example embodiment may be used in manufacturing a battery pack.

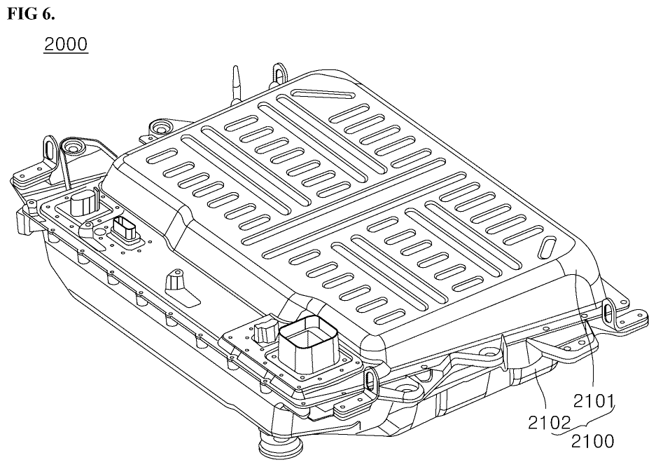

FIG. 6 is a view illustrating a battery pack, according to one example embodiment.

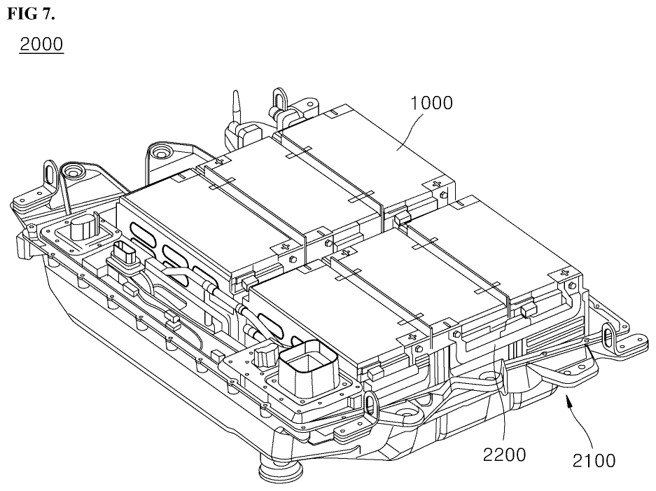

FIG. 7 is a view illustrating a battery pack, according to one example embodiment.

A battery pack 2000 according to one example embodiment includes an assembly of electrically connected individual batteries, and a pack case accommodating the battery pack 2000. In the drawings, for convenience of illustration of the drawings, illustration of components such as a busbar, a cooling unit, an external terminal, and the like, for electrical connection of batteries, has been omitted.

For example, the battery pack 2000 may include a plurality of battery modules 1000 (for example, including the battery module described above with reference to FIG. 5) and a pack case 2100 for accommodating the battery modules 1000. For example, the pack case 2100 may include first and second pack cases 2101 and 2102 coupled to each other in directions facing each other while the plurality of battery modules 1000 are interposed therebetween. The plurality of battery modules 1000 may be electrically connected to each other using a busbar 2200, or the plurality of battery modules 1000 may be electrically connected to each other in series or in parallel or by a combination of serial and parallel connections to obtain a required electrical output.

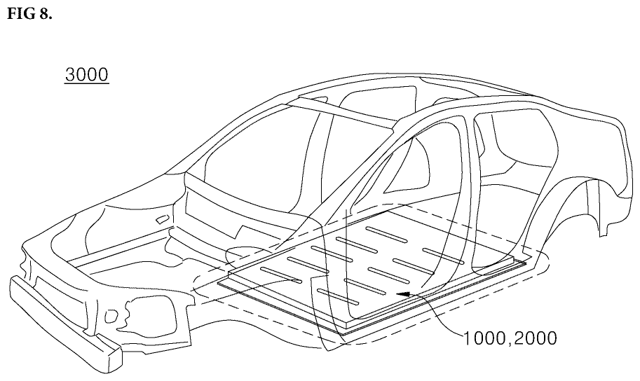

FIG. 8 is a view illustrating a vehicle body and vehicle body components, according to one example embodiment.

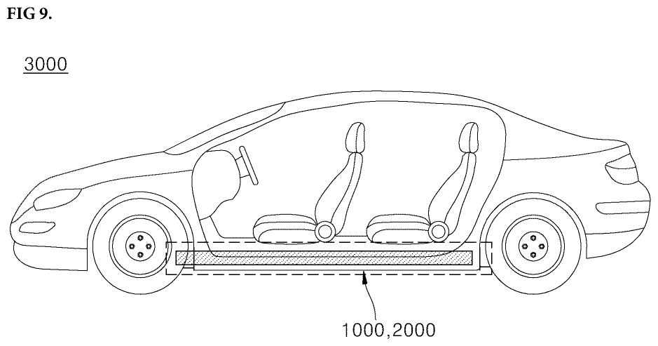

FIG. 9 is a view illustrating a vehicle body and vehicle body components, according to one example embodiment.

The battery pack 2000 according to one example embodiment described above with reference to FIGS. 6 and 7 may be mounted in a vehicle 3000. For example, the vehicle 3000 may be, e.g., an electric vehicle, a hybrid vehicle, or a plug-in hybrid vehicle. The vehicle may be, e.g., a four-wheel vehicle or a two-wheel vehicle.

As illustrated in FIGS. 8 and 9, the vehicle 3000 according to one example embodiment includes the battery modules 1000 and/or the battery pack 2000 including the battery modules 1000 according to one example embodiment of the present disclosure. The vehicle 3000 is configured to function by receiving power from the battery modules 1000 and/or the battery pack 2000 including the battery modules 1000 according to one example embodiment of the present disclosure.

Hereinafter, examples and comparative examples of the present disclosure are described. However, the following examples are merely embodiments of the present disclosure, and the present disclosure is not limited to the following examples.

### Example 1

### Preparation of Composition for Aerogel-Containing Layer

A first mixed solution was prepared by adding polyvinyl alcohol (Sigma Aldrich, PVA) as a binder to ultrapure water as a solvent and sequentially mixing the binder at 30 rpm with an open blade and 700 rpm with a despa blade. A second mixed solution was prepared by adding an aerogel (BET specific surface area: 800 m²/g) to the first mixed solution and sequentially mixing the first mixed solution at 70 rpm with the open blade and 1500 rpm with the despa blade. A composition for an aerogel-containing layer was prepared by adding glass wool as a fibrous support to the second mixed solution and sequentially mixing the second mixed solution at 30 rpm with the open blade and 1200 rpm with the despa blade. A planetary mixer (D&Tech, PT-005) was used for mixing.

The prepared composition for an aerogel-containing layer was in the form of a slurry, and the composition included 30 wt % aerogel, 60 wt % glass wool, and 10 wt % polyvinyl alcohol based on solid content.

### Manufacturing of Heat Insulation Sheet

The prepared composition for an aerogel-containing layer was applied on a mica sheet (Famica, Muscovite) with a thickness of 0.1 mm as a first base layer, and a mica sheet (Famica, Muscovite) with a thickness of 0.1 mm as a second base layer was stacked on the composition for an aerogel-containing layer and coated using a roll rolling method. Then, a heat insulation sheet stacked in the order of the mica sheet-the aerogel-containing layer-the mica sheet was manufactured by drying the stack at 60° C. for 24 hours.

A composition for a coating layer was prepared by adding polyvinyl alcohol (Sigma Aldrich, PVA) as a binder to ultrapure water as a solvent and mixing silica (average particle diameter D50: 500 nm) sol, and a heat insulation sheet in which a coating layer including polyvinyl alcohol and silica was formed on the entire surface including the upper surface, lower surface, and side surfaces of the base sheet was manufactured by completely immersing the base sheet in the prepared composition for a coating layer and drying the composition at 60° C. for 24 hours. The composition for a coating layer was in the form of a slurry and included 90 wt % silica and 10 wt % polyvinyl alcohol based on solid content. A thickness of the aerogel-containing layer in the manufactured heat insulation sheet was 2 mm, and a thickness of the coating layer was 100 μm.

### Example 2

A base sheet was manufactured in the same manner as in Example 1.

A composition for a coating layer was prepared by adding polyvinyl alcohol (Sigma Aldrich, PVA) as a binder to ultrapure water as a solvent and mixing alumina (average particle diameter D50: 500 nm) sol, and a heat insulation sheet in which a coating layer including polyvinyl alcohol and alumina was formed on the entire surface of the base sheet was manufactured by completely immersing the base sheet in the prepared composition for a coating layer and drying the composition at 60° C. for 24 hours. The composition for a coating layer was in the form of a slurry and included 90 wt % alumina and 10 wt % polyvinyl alcohol based on solid content. A thickness of the aerogel-containing layer in the manufactured heat insulation sheet was 2 mm, and a thickness of the coating layer was 100 μm.

### Example 3

A heat insulation sheet was manufactured in the same manner as in Example 2, with a difference that in Example 2, the composition for an aerogel-containing layer was changed to 60 wt % aerogel, 25 wt % glass wool, and 15 wt % polyvinyl alcohol based on solid content.

### Example 4

A heat insulation sheet was manufactured in the same manner as in Example 2, with a difference that in Example 2, the composition for an aerogel-containing layer was changed to 65 wt % aerogel, 25 wt % glass wool, and 10 wt % polyvinyl alcohol based on solid content.

### Example 5

A heat insulation sheet was manufactured in the same manner as in Example 2, with a difference that in Example 2, the composition for an aerogel-containing layer was changed to 45 wt % aerogel, 50 wt % glass wool, and 5 wt % polyvinyl alcohol based on solid content.

### Example 6

A heat insulation sheet was manufactured in the same manner as in Example 2, with a difference that in Example 2, a water-dispersible polyurethane (Sigma Aldrich) instead of polyvinyl alcohol was used when preparing the composition for an aerogel-containing layer.

### Example 7

A first mixed solution was prepared by adding polyvinyl alcohol (Sigma Aldrich) and water-dispersible polyurethane (Sigma Aldrich) as a binder and surfactant (Triton-X100, Sigma Aldrich) as a dispersant to ultrapure water as a solvent and sequentially mixing the first mixed solution at 30 rpm with an open blade and 700 rpm with a despa blade. A second mixed solution was prepared by adding an aerogel (BET specific surface area: 800 m²/g) to the first mixed solution and sequentially mixing the second mixed solution at 70 rpm with the open blade and 1500 rpm with the despa blade. A composition for an aerogel-containing layer was prepared by adding glass wool to the second mixed solution and sequentially mixing the second mixed solution at 30 rpm with the open blade and 1200 rpm with the despa blade. A planetary mixer (D&Tech, PT-005) was used for mixing.

The prepared composition for an aerogel-containing layer was in the form of a slurry and included 30 wt % aerogel, 60 wt % glass wool, 3 wt % polyvinyl alcohol, 6.9 wt % water-dispersible polyurethane, and 0.1 wt % dispersant.

A heat insulation sheet was manufactured in the same manner as in Example 2 using the prepared composition for an aerogel-containing layer.

### Example 8

A base sheet was manufactured in the same manner as in Example 1.

A composition for a coating layer was prepared by adding polyvinyl alcohol (Sigma Aldrich, PVA) as a binder to ultrapure water as a solvent and mixing silica (average particle diameter D50: 500 nm) sol and alumina (average particle diameter D50: 500 nm) sol, and a heat insulation sheet in which a coating layer including polyvinyl alcohol, silica, and alumina was formed on the entire surface of the base sheet was manufactured by completely immersing the base sheet in the prepared composition for a coating layer and drying the prepared composition at 60° C. for 24 hours. The composition for a coating layer was in the form of a slurry and included 30 wt % silica, 60 wt % alumina, and 10 wt % polyvinyl alcohol based on solid content. A thickness of the aerogel-containing layer in the manufactured heat insulation sheet was 2 mm, and a thickness of the coating layer was 100 μm.

### Comparative Example 1

A base sheet was manufactured in the same manner as in Example 1. The manufactured base sheet was included as a heat insulation sheet without forming the coating layer.

### Comparative Example 2

A base sheet was manufactured in the same manner as in Example 4. The manufactured base sheet was included as a heat insulation sheet without forming the coating layer.

### Comparative Example 3

A base sheet was manufactured in the same manner as in Example 6. The manufactured base sheet was included as a heat insulation sheet without forming the coating layer.

### Comparative Example 4

A base sheet was manufactured in the same manner as in Example 3. The manufactured base sheet was included as a heat insulation sheet without forming the coating layer.

### Comparative Example 5

A base sheet was manufactured in the same manner as in Example 5. The manufactured base sheet was included as a heat insulation sheet without forming the coating layer.

### Comparative Examples 6 and 7

Heat insulation sheets were manufactured in the same manner as in Example 1, with a difference that in Example 1, the aerogel-containing layer was changed as shown in Table 1 below.

The following physical properties were evaluated for the heat insulation sheets manufactured in Examples and Comparative Examples.
(1) Heat insulation (units: ° C.): Samples were manufactured by cutting the manufactured heat insulation sheet into 232 mm wide and 115 mm wide, each heat insulation sheet was placed between a pair of facing 1 mm thick aluminum plates and placed on a heat press, an upper plate of the heat press was heated to 350° C., and a lower plate of the heat press was maintained at a starting temperature of 40° C. without heating. Then, a pressure of 20 kN was applied to the lower plate of the heat press, and a temperature of the lower plate of the heat press was measured after 11 minutes. The decrease in the temperature of the lower plate indicates that the heat insulation of the heat insulation sheet is better.
(2) Dust resistance (units: %): Samples were manufactured by cutting the manufactured heat insulation sheet into a length of 12 inches and a width of 12 inches, and a weight of the sample was measured. The weight of the sample was measured after vibrating the sample under vibration conditions (frequency: 24 Hz/3 mm, vibration time: 6 hours) using a vibration tester (ASTM C592-04). A weight reduction rate was evaluated according to the following equation.

$$Weight reduction rate = [ ( weight of sample before vibrations ) - ( weight of sample after vibrations ) ] / ( weight of sample before vibrations ) \times 100$$

(3) Resistance to flame passage (units: seconds): Samples were manufactured by cutting the manufactured heat insulation sheet into a length of 100 mm and a width of 70 mm, and a temperature sensor was mounted on the sample. Using a torch capable of emitting flames on the mounted sample, flames were applied so that a temperature of a surface of the sample reached 1200° C. At this time, the time at which the sample collapsed due to cracks appearing on the exterior of the sample was checked. A longer time indicates better resistance to flame passage.

TABLE 1

| | Aerogel-containing layer | | | | | | | |
|---|---|---|---|---|---|---|---|---|
| | Fibrous | | | Type of | Coating | Heat | Dust | |
| | support | Aerogel | Binder | binder | layer | insulation | resistance | Resistance |
| Example 1 | 60 | 30 | 10 | PVA | Silica | 86.9 | 0.00 | 521 |
| Example 2 | 60 | 30 | 10 | PVA | Alumina | 87.3 | 0.00 | 650 |
| Example 3 | 25 | 60 | 15 | PVA | Alumina | 76.3 | 0.00 | 608 |
| Example 4 | 25 | 65 | 10 | PVA | Alumina | 75.2 | 0.00 | 661 |
| Example 5 | 50 | 45 | 5 | PVA | Alumina | 80.1 | 0.01 | 663 |
| Example 6 | 60 | 30 | 10 | PU | Alumina | 88.1 | 0.00 | 649 |
| Example 7 | 60 | 30 | 10* | PVA + | Alumina | 87.2 | 0.00 | 643 |
| | | | | PU | | | | |
| Example 8 | 60 | 30 | 10 | PVA | Silica + | 87.9 | 0.00 | 647 |
| | | | | | alumina | | | |
| Comparative | 60 | 30 | 10 | PVA | None | 87.3 | 0.00 | 202 |
| Example 1 | | | | | | | | |
| Comparative | 25 | 65 | 10 | PVA | None | 76.1 | 0.06 | 210 |
| Example 2 | | | | | | | | |
| Comparative | 60 | 30 | 10 | PU | None | 87.2 | 0.06 | 199 |
| Example 3 | | | | | | | | |
| Comparative | 25 | 60 | 15 | PVA | None | 76.9 | 0.05 | 157 |
| Example 4 | | | | | | | | |
| Comparative | 50 | 45 | 5 | PVA | None | 79.9 | 0.13 | 206 |
| Example 5 | | | | | | | | |
| Comparative | 49.7 | 50 | 0.3 | PVA | Alumina | 80.2 | 3.32 | 193 |
| Example 6 | | | | | | | | |
| Comparative | 35 | 40 | 25 | PVA | Alumina | 81.0 | 0.00 | 255 |
| Example 7 | | | | | | | | |

*Example 7 included 10 wt % binder, 3 wt % polyvinyl alcohol, 6.9 wt % water-dispersible polyurethane, and 0.1 wt % dispersant.

As shown in Table 1, the heat insulation sheets of the Examples provided desired or improved heat insulation, desired or improved dust resistance, and desired or improved heat resistance and durability.

On the other hand, the heat insulation sheets of Comparative Examples 1 to 5 without the inorganic layer exhibited poor dust resistance or poor heat resistance and durability. The heat insulation sheet in Comparative Example 6 not satisfying the aerogel-containing layers of the Examples exhibited poor dust resistance, heat resistance, and durability. The heat insulation sheet in Comparative Example 7 not satisfying the aerogel-containing layers of the Examples exhibited poor heat resistance and durability.

The heat insulation sheet for a rechargeable lithium battery according to one example embodiment can reduce or suppress heat propagation and/or heat transfer in a module by providing desired or improved heat insulation, thereby increasing the stability of the module.

The heat insulation sheet for a rechargeable lithium battery according to one example embodiment can improve the manufacturing processability of the heat insulation sheet and the battery module by providing desired or improved dust resistance.

A heat insulation sheet for a rechargeable lithium battery according to one example embodiment can increase the lifetime of a battery module by exhibiting desired or improved heat resistance and durability.

Although example embodiments of the present disclosure have been described above, the present disclosure is not limited thereto and may be modified in any form within the scope of the claims, the detailed description of the present disclosure, and the accompanying drawings, and the modifications also fall within the scope of the present disclosure.

What is claimed is:

1. A heat insulation sheet for a rechargeable lithium battery, the heat insulation sheet comprising:
a base sheet including a first base layer and an aerogel-containing layer that are stacked on each other; and
an inorganic layer formed on at least substantially an entire surface of the base sheet,
wherein the aerogel-containing layer includes a fibrous support, an aerogel, and a binder, and
in the aerogel-containing layer, the fibrous support is included in an amount ranging from about 5 wt % to about 70 wt %, the aerogel is included in an amount ranging from about 10 wt % to about 90 wt %, and the binder is included in an amount ranging from about 0.5 wt % to about 20 wt %.

2. The heat insulation sheet of claim 1, wherein a second base layer is further stacked on the aerogel-containing layer.

3. The heat insulation sheet of claim 1, wherein the aerogel-containing layer comprises a noncontinuous layer independent of the first base layer.

4. The heat insulation sheet of claim 2, wherein the aerogel-containing layer comprises a noncontinuous layer independent of the second base layer.

5. The heat insulation sheet of claim 1, wherein the inorganic layer comprises one or more of silicon oxide and aluminum oxide.

6. The heat insulation sheet of claim 5, wherein the inorganic layer further comprises a binder.

7. The heat insulation sheet of claim 1, wherein the binder comprises one or more of polyvinyl alcohol, polyethylene glycol, polyacrylamide, polyvinylpyrrolidone, polyurethane, and polyester.

8. The heat insulation sheet of claim 1, wherein the fibrous support comprises glass wool.

9. The heat insulation sheet of claim 1, wherein the first base layer comprises a mica sheet.

10. The heat insulation sheet of claim 2, wherein the second base layer comprises a mica sheet.

11. A rechargeable lithium battery module comprising:
a plurality of battery cells that face each other; and
the heat insulation sheet of claim 1 between the plurality of battery cells.
